(19) United States
(12) Patent Application Publication
(10) Pub. No.: US 2012/0299848 A1
(43) Pub. Date: Nov. 29, 2012

(54) INFORMATION PROCESSING DEVICE, DISPLAY CONTROL METHOD, AND PROGRAM

(76) Inventors: Fuminori HOMMA, Tokyo (JP); Ikuo YAMANO, Tokyo (JP); Shunichi Kasahara, Kanagawa (JP); Tatsushi Nashida, Kanagawa (JP)

(21) Appl. No.: 13/469,793

(22) Filed: May 11, 2012

(30) Foreign Application Priority Data
May 26, 2011 (JP) 2011-118319

(51) Int. Cl. G06F 3/041

(52) U.S. Cl. 345/173

(57) ABSTRACT

There is provided an information processing device including a display control unit configured to identify hover coordinates displayed on a touch screen of a touch panel and a tilt of a device body, and determine an offset value of the identified hover coordinates in accordance with the identified tilt of the device body.

### BACKGROUND

The present disclosure relates to an information processing device, a display control method, and a program.

When operating a touch panel or the like using a finger, a stylus, or the like, it is possible to change the mode of an input operation using a specific operation key provided on the device body or a specific operation area provided on the touch panel. In a normal input operation mode, a release operation performed immediately after a touch corresponds to a normal click of a mouse operation. Examples of mouse operations include not only the click but also an operation of moving only a mouse pointer. A user should selectively use such operations according to circumstances. A mode corresponding to an operation of moving a mouse pointer is referred to as a hover mode, and display performed for an operation of moving the mouse pointer is referred to as a hover display.

Even when a finger or the like does not touch a touch screen, but when the finger or the like gets near the touch screen to a certain degree, if the display state changes in accordance with the distance between the touch screen and the finger, it becomes possible to realize an unprecedented information display state. For example, when a configuration is used in which the mode of the display state is switched between an input operation mode where a finger touches a touch screen and a hover mode in which a finger gets close to the touch screen by a predetermined distance, it becomes possible to perform many types of operations while minimizing the occupied area.

For example, JP 2008-117371A proposes a technique of, using a capacitive display panel, detecting a touch position of a fingertip when the fingertip touches a touch screen of the display panel and detecting the position of the fingertip when the fingertip gets close to the touch screen.

### SUMMARY

However, when one moves his/her finger closer to a hover-displayed target (a hover target), the line of sight fixed on the hover target is blocked by the operating finger, so that characters and the like of the hover target are hidden behind the finger and thus it becomes difficult to distinguish whether the hover target correctly responds to the finger operation. This is referred to as a fat finger.

In light of the foregoing, it is desirable that an offset of the hover coordinates be optimized so that the hover target is not hidden behind the finger.

According to an embodiment of the present disclosure, there is provided an information processing device including a display control unit configured to identify hover coordinates displayed on a touch screen of a touch panel and a tilt of a device body, and determine an offset value of the identified hover coordinates in accordance with the identified tilt of the device body.

According to another embodiment of the present disclosure, there is provided a display control method, including identifying hover coordinates displayed on a touch screen of a touch panel, identifying a tilt of a device body, and determining an offset value of the identified hover coordinates in accordance with the identified tilt of the device body.

According to still another embodiment of the present disclosure, there is provided a program for causing a computer to execute a process of identifying hover coordinates displayed on a touch screen of a touch panel, a process of identifying a tilt of a device body, and a process of determining an offset value of the identified hover coordinates in accordance with the identified tilt of the device body.

As described above, according to the embodiments of the present disclosure, it is possible to optimize an offset of the hover coordinates so that the hover target is not hidden behind the finger.

### BRIEF DESCRIPTION OF THE DRAWINGS

FIG. 1 is a hardware configuration diagram of an information processing device in accordance with first to third embodiments;

FIG. 2 is a diagram illustrating proximity to and touch on a touch screen;

FIG. 3 is a diagram illustrating a fat finger;

FIG. 4 is a diagram illustrating a tilt of a device body and offset;

FIG. 5 is a functional configuration diagram of the information processing device in accordance with the first to third embodiments;

FIG. 6 is a flowchart showing an offset process for the hover coordinates in accordance with the first embodiment;

FIG. 7 is a table showing the relationship between a tilt of the device body and offset;

FIG. 8 is a diagram illustrating the relationship between a tilt of the device body and offset;

FIG. 9 is a diagram showing an example of a hover display;

FIG. 10 is a diagram illustrating the relationship between a tilt of the line of sight and offset;

FIG. 11 is a flowchart showing an offset process for the hover coordinates in accordance with the second embodiment;

FIG. 12 is a table showing the relationship between the difference between a tilt of the device body and a tilt of the line of sight and offset; and

FIG. 13 is a diagram showing an example of a hover display; and

FIG. 14 is a flowchart showing an offset process for the hover coordinates in accordance with the third embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

1. Fat Finger

2. First Embodiment (Tilt of Device Body and Offset)

3. Second Embodiment (Difference between Tilt of Device Body and Tilt of Line of Sight and Offset)

4. Third Embodiment (Determination of if Offset Value is Positive Value or Negative Value)

### 1. Fat Finger

First, a fat finger will be described. Although a hover cursor will be exemplarily described as an example of a hover display, the hover display method may use any figure or image.

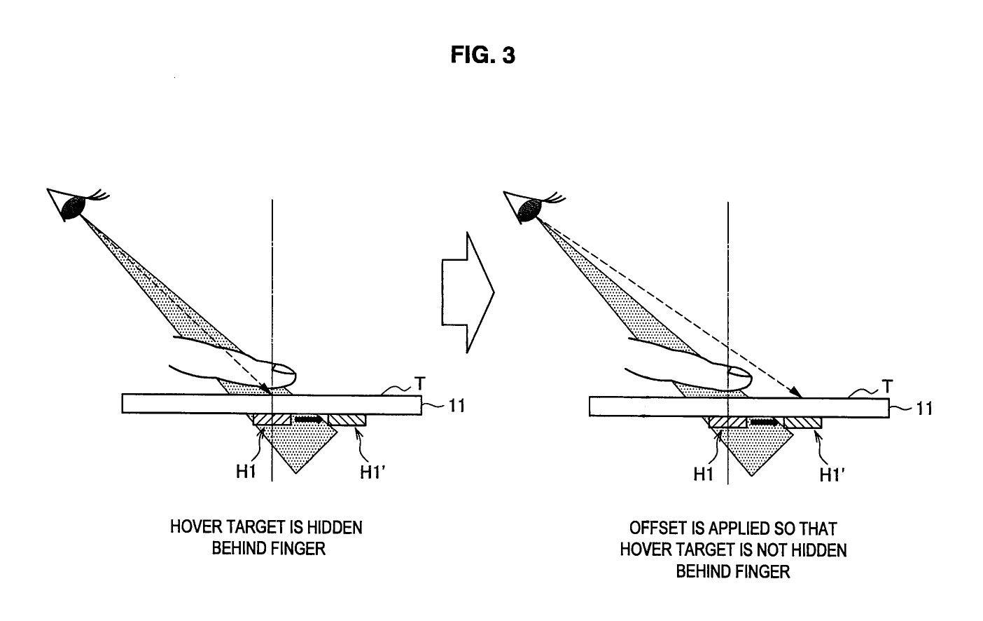

As shown in the left view of FIG. 3, when a finger is placed in proximity to a touch screen T of a device body 11, which is a housing of an information processing device, for a period longer than or equal to a predetermined period of time, the mode transitions to the hover mode, so that a hover cursor H1 is hover-displayed. The hover cursor H1 is a figure that indicates the position of an input operation target. When the finger moves in an upward direction of the touch screen T while being in proximity to the touch screen T, the hover cursor H1 moves. When the finger touches the hover cursor H1, characters and the like in the hover cursor H1 are input.

However, when the finger is moved closer to the hover cursor H1, the line of sight fixed on the hover target is blocked by the operating finger, so that it becomes difficult to distinguish whether the hover target correctly respond to the finger operation. This is referred to as a fat finger.

Thus, in order to prevent the line of sight fixed on the hover target from being hidden behind the operating finger, the hover coordinates indicating the position of the hover cursor H1 are slightly offset, so that a hover cursor H1′ is displayed on the hover coordinates after the offset. In the right view of FIG. 3, the hover cursor H1′ has moved to a position where the line of sight fixed on the hover target is not blocked by the operating finger. Accordingly, it becomes possible to distinguish whether the hover target correctly responds to the finger.

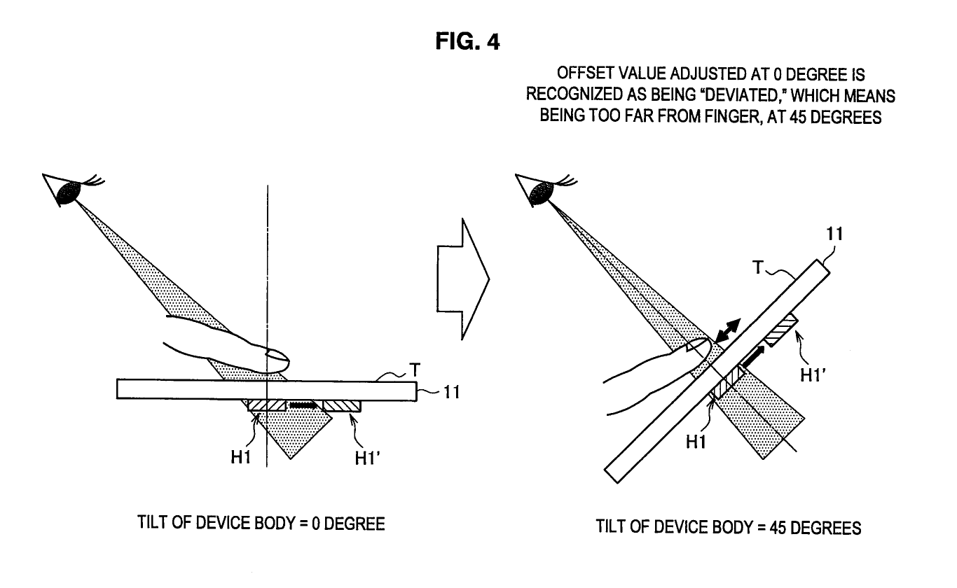

However, if the offset value of the hover coordinates when the tilt of the device body 11 is 0 degree as shown in the left view of FIG. 4 and the offset value of the hover coordinates when the tilt of the device body 11 is 45 degrees as shown in the right view of FIG. 4 are set to the same value, there is a possibility that, if the tilt of the device body 11 is 45 degrees, the hover cursor H1′ displayed on the hover coordinates after the offset may be located too far from the finger, so that the user may recognize it as a “deviation.”

### 2. First Embodiment

Thus, in the information processing device 10 in accordance with the first embodiment, an offset value of the hover coordinates is set variable in accordance with a tilt of the device body 11, whereby the hover cursor is displayed at an appropriate position. The information processing device 10 is a device having mounted thereon sensors that can detect a contact position and a proximity position of a finger of a user and a tilt of the device body. It is acceptable as long as the information processing device 10 is a device with a proximity touch panel.

### (Hardware Configuration)

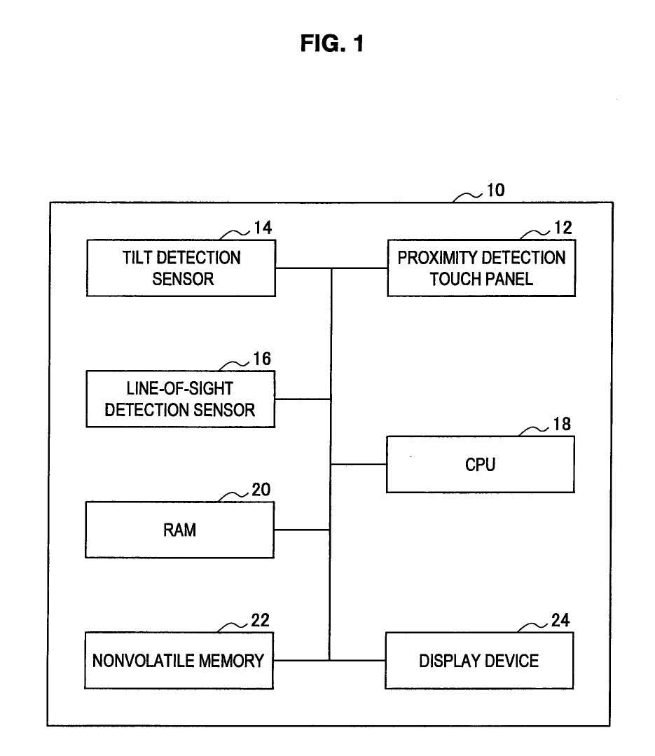

FIG. 1 shows the hardware configuration of the information processing device 10 in accordance with the first embodiment. The information processing device 10 in accordance with the first embodiment includes a proximity detection touch panel 12, a tilt detection sensor 14, a line-of-sight detection sensor 16, a CPU 18, RAM 20, nonvolatile memory 22, and a display device 24.

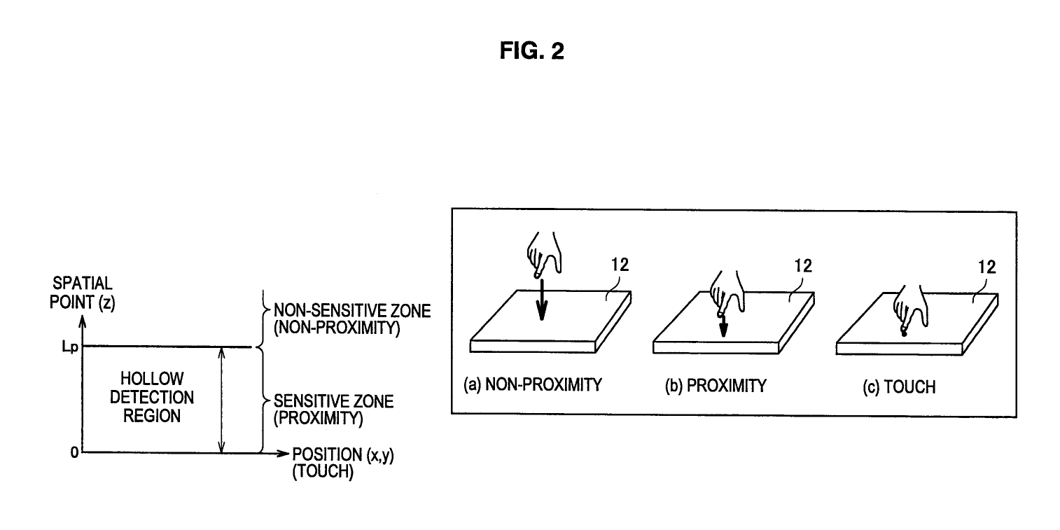

The proximity detection touch panel 12 is a display panel that can detect proximity. For the proximity detection touch panel 12, a capacitive display panel is used. For example, as shown in FIG. 2, when the distance between the finger and the touch screen of the proximity detection touch panel 12 is longer than a predetermined threshold Lp, the proximity detection touch panel 12 detects nothing (FIG. 2(a): non-proximity state, non-sensitive zone). When the distance between the finger and the touch screen becomes shorter than the threshold Lp, and the finger enters an intermediate detection area and a predetermined period of time has elapsed, the proximity detection touch panel 12 detects the proximity position of the finger (FIG. 2(b): proximity state, sensitive zone). When the finger touches the touch screen, the proximity detection touch panel 12 detects the touch position of the finger (FIG. 2(c): touch state).

As described above, the proximity detection touch panel 12 can detect the proximity position of the finger in the depth direction (coordinate in the z direction) from the touch screen of the proximity detection touch panel 12 and can also detect the contact position (coordinates in the x direction and the y direction) of the finger on the touch screen.

Referring again to FIG. 1, the tilt detection sensor 14 is mounted on the device body 11 of the information processing device 10 and calculates the tilt angle in the x-axis direction and the y-axis direction of the device body 11 in the basic attitude (the tilt angle of the device body 11=zero degree) with respect to the reference plane. The tilt detection sensor 14 can be implemented using a gyro sensor as an example of an acceleration sensor.

The line-of-sight detection sensor 16 detects the line of sight of the user who is operating the proximity detection touch panel 12. For example, the line-of-sight detection sensor 16 chases motions of the pupils of the eyes with a camera using a line-of-sight detection method. It is also possible to detect a tilt of the line of sight by detecting irises, pupils, or a Purkinje image (reflection image) from an image using an optical sensor.

A sensor value detected by each of the proximity detection touch panel 12, the tilt detection sensor 14, and the line-of-sight detection sensor 16 is transmitted to and stored in the RAM 20 or the nonvolatile memory 22. The CPU 18 is connected to each unit, and acquires various sensor values stored in the RAM 20 or the nonvolatile memory 22, and calculates a finger touch position, a finger proximity position, a tilt of the device body, and a tilt of the line of sight on the basis of the various sensor values.

In the RAM 20 or the nonvolatile memory 22, a program for executing an offset process for the hover coordinates, a table for determining an offset value, and various data such as a threshold are stored. The CPU 18 executes an offset process for the hover coordinates by reading and executing the program. The display device 24 displays a hover cursor or the like at the position of the hover coordinates after the offset process. The CPU 18 is connected to the display device 24 and processes information transmitted from the display device 24.

(Functional Configuration)

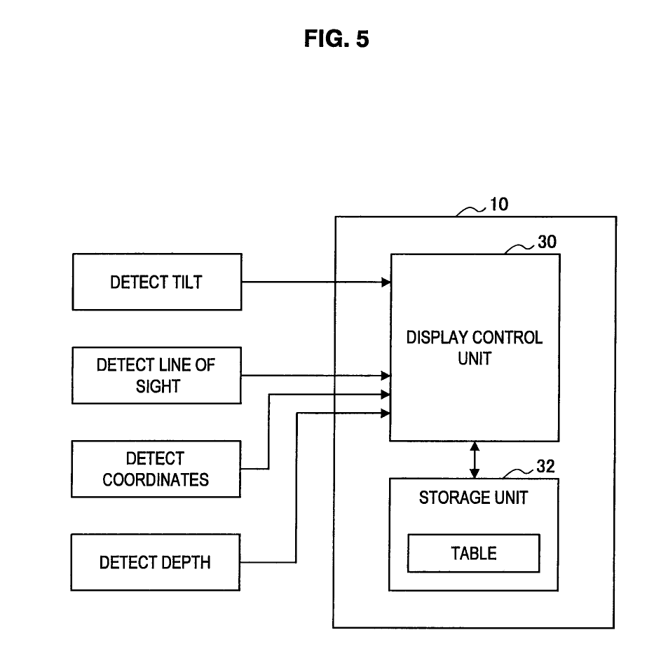

The hardware configuration of the information processing device 10 in accordance with the first embodiment has been described above with reference to FIG. 1. Next, the functional configuration of the information processing device 10 in accordance with the first embodiment will be described with reference to FIG. 5. The information processing device 10 in accordance with the first embodiment includes a display control unit 30 and a storage unit 32.

The display control unit 30 identifies the hover coordinates (coordinates in the x direction and the y direction) displayed on the touch screen of the proximity detection touch panel 12 from a result of detection of the hover coordinates by the proximity detection touch panel 12. The display control unit 30 identifies the proximity position (coordinates in the z direction) of the finger from a result of detection of the depth by the proximity detection touch panel 12. The display control unit 30 identifies a tilt of the device body 11 from a result of detection of a tilt of the device boly 11 by the tilt detection sensor 14. The display control unit 30 may determine an offset value of the hover coordinates in accordance with the identified tilt of the device body 11. In addition, the display control unit 30 identifies a tilt of the line of sight with respect to the touch screen from a result of detection of the line of sight by the line-of-sight detection sensor 16. The display control unit 30 may determine an offset value in accordance with the difference between a tilt of the device body and a tilt of the line of sight. The display control unit 30 corrects the hover coordinates by adding the offset value to the hover coordinates, and thus shifts the hover display on the touch screen.

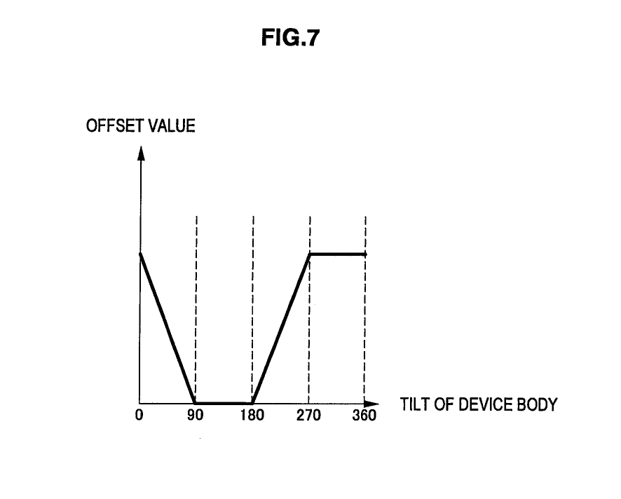

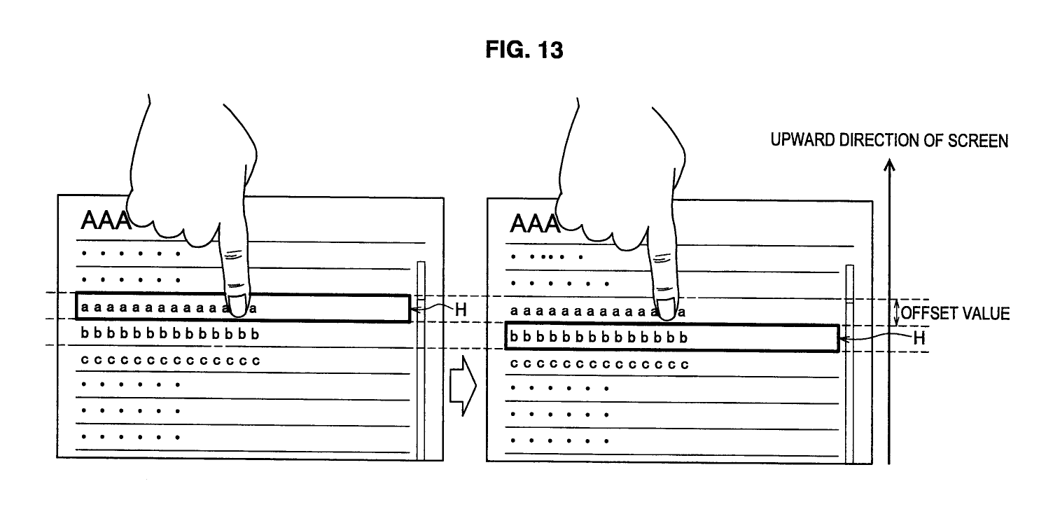

The storage unit 32 stores the threshold Lp for determining proximity or non-proximity and a table for determining an offset value (FIGS. 7 and 13). The display control unit 30 can determine an offset value on the basis of each table.

### (Operation)

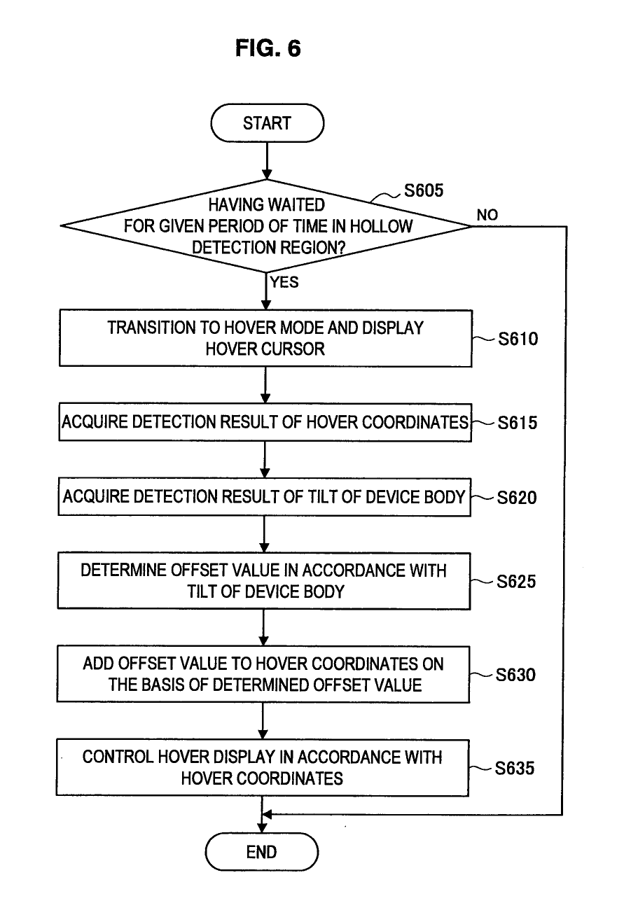

The functional configuration of the information processing device 10 in accordance with the first embodiment has been described with reference to FIG. 5. Next, the operation of the information processing device 10 in accordance with the fist embodiment will be described with reference to FIGS. 6 to 9.

FIG. 6 is a flowchart showing the operation of the information processing device 10 in accordance with the first embodiment. As shown in FIG. 6, first, if it is detected that a finger has been waiting for a given period of time within a hollow detection region (S605), the display control unit 30 transitions mode to the hover mode and causes the display device 24 to display a hover cursor (S610).

In addition, the display control unit 30 acquires a result of detection of the hover coordinates form the proximity detection touch panel 12 (S615), and acquires a result of detection of a tilt of the device body 11 from the tilt detection sensor 14 (S620). Next, the display control unit 30 determines an offset value of the hover cursor in accordance with the tilt of the device body 11 (S625). Hereinafter, the relationship between the tilt of the device body and the offset value will be specifically described with reference to FIG. 7.

FIG. 7 is a table showing the relationship between a tilt of the device body and an offset value. As shown in FIG. 7, when a tilt of the device body 11 is in the range of 0 to 90 degrees, for example, the larger the tilt, the lower the offset value. Meanwhile, when a tilt of the device body 11 is in the range of 90 to 180 degrees, the offset value is zero.

When a tilt of the device body 11 is in the range of 180 to 270 degrees, the larger the tilt, the higher the offset value. Further, the display control unit 30, when a tilt of the device body 11 is in the range of 270 to 360 degrees, sets the offset value to be constant, and the offset value has the same value as when a tilt of the device body 11 is 0 degree. In this table, the offset value has a positive value in any range.

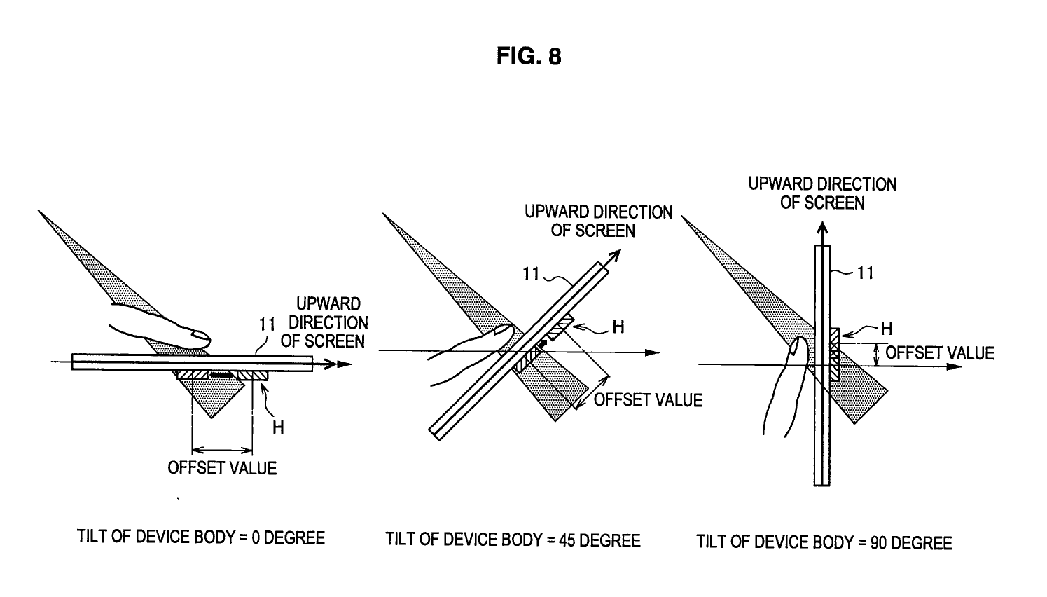

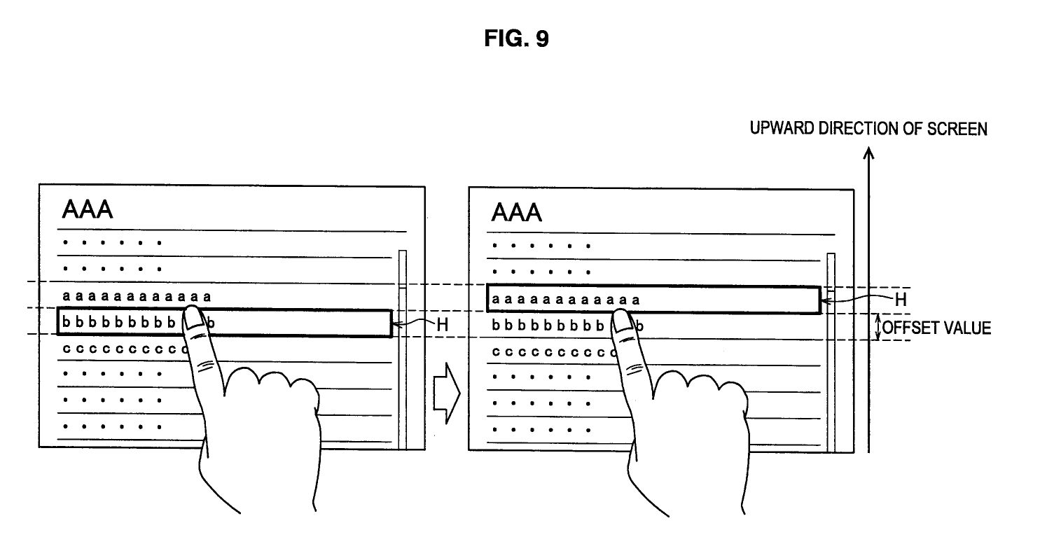

Referring again to FIG. 6, the display control unit 30 adds the offset value determined in S625 to the hover coordinates acquired in S615 (S630). Then, the display control unit 30 performs control so that a hover cursor is displayed at the hover coordinates calculated in S630 (S635). Heretofore, the operation of the information processing device 10 will be described. Hereinafter, display control of the hover cursor will be described more specifically with reference to FIGS. 8 and 9.

FIG. 8 is a diagram illustrating an offset value that is added to the hove coordinates at a representative tilt of the device body 11. As shown in FIG. 8, an offset value added to the hover coordinates is the largest when a tilt of the device body 11 is 0 degree and is the smallest when a tilt of the device body 11 is 90 degrees. An offset value when a tilt of the device body 11 is 45 degrees is an intermediate value between the offset value when the tilt is 0 degree and the offset value when the tilt is 90 degrees. Accordingly, it becomes possible to prevent characters and the like indicated by the hover cursor H from being hidden behind the finger in accordance with a tilt of the device body 11 and display the hover cursor H at an appropriate position.

FIG. 9 is a hover display example. Unless an offset value is added to the hover coordinates, characters and the like that are the hover target indicated by the hover cursor H are hidden behind the finger as shown in the left view of FIG. 9. Meanwhile, in this embodiment, an offset value is controlled variably in accordance with a tilt of the device body, whereby it becomes possible to control a hover display so that characters and the like that are the hover target indicated by the hover cursor H are not hidden behind the finger and the hover cursor H is not located too far from the finger as shown in the right view of FIG. 9. Accordingly, it becomes possible to, by estimating an operation context of the user in accordance with a tilt of the device body 11 and adjusting the offset value in hover display to an optimum value, distinguish whether the hover target correctly responds to the finger operation.

### (Variation)

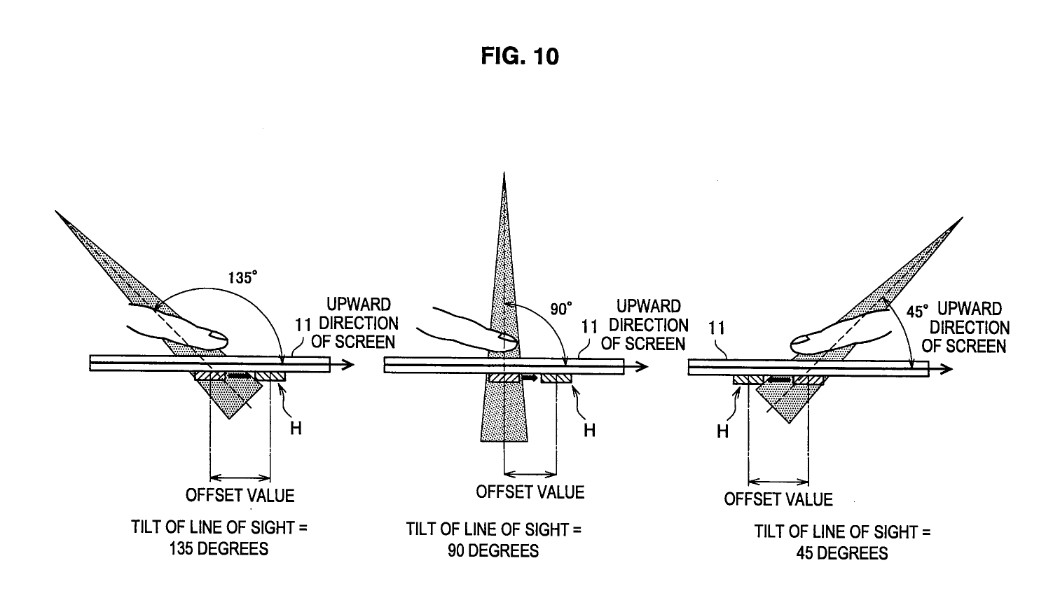

In the information processing device 10 in accordance with the first embodiment, an offset value is controlled variably in accordance with a tilt of the device body 11. In contrast, in this variation, an offset value is controlled variably in accordance with a tilt of the line of sight. A variation will be described with reference to FIG. 10.

FIG. 10 shows an offset value that is added to the hover coordinates at a representative tilt of the line of sight. As shown in FIG. 10, an offset value added to the hover coordinates may have, when a tilt of the line of sight is 135 degrees and 45 degrees, the same absolute value but opposite (positive/negative) signs and have, when a tilt of the line of sight is 90 degrees, a value smaller than when a tilt of the line of sight is 135 degrees and 45 degrees. Accordingly, it becomes possible to prevent characters and the like in the hover cursor H from being hidden behind the finger in accordance with a tilt of the line of sight, and display the hover cursor H at an appropriate position.

### 3. Second Embodiment

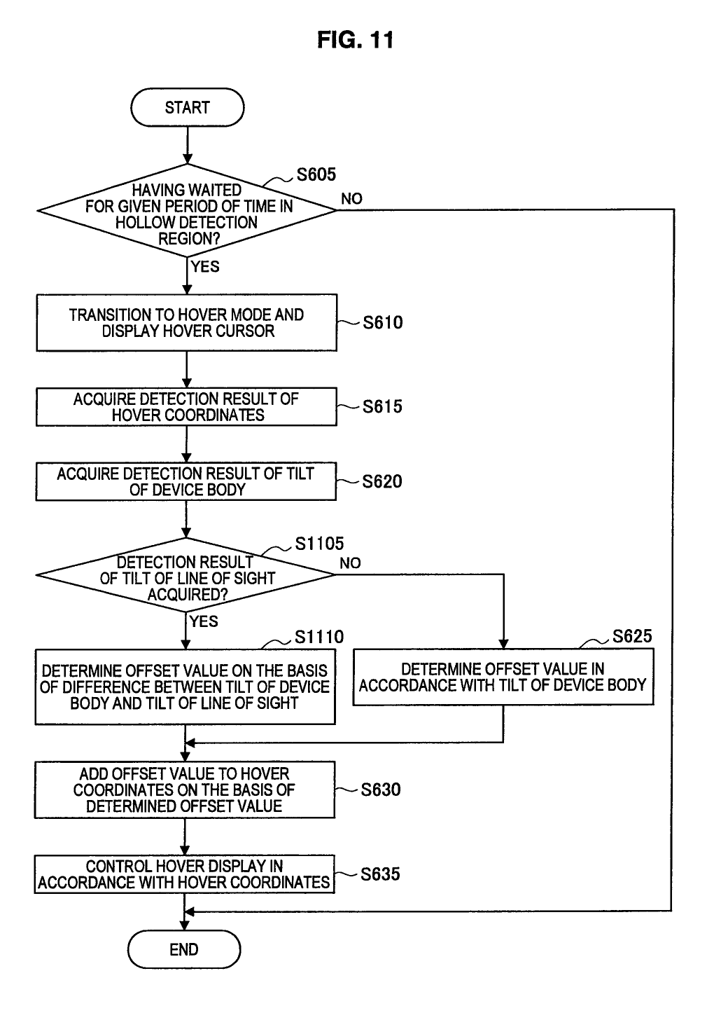

Next, the information processing device 10 in accordance with the second embodiment will be described. The hardware configuration and the functional configuration of the information processing device 10 in accordance with the second embodiment are the same as those in the first embodiment. Thus, description thereof is omitted herein. Hereinafter, the operation of the information processing device 10 in accordance with the second embodiment will be described with reference to FIGS. 11 to 13.

### (Operation)

FIG. 11 is a flowchart showing the operation of the information processing device 10 in accordance with the second embodiment. S605 to S620 are the same as those in the first embodiment. Thus, if it is detected that a finger has been waiting for a given period of time within a hollow detection region (S605), the display control unit 30 transitions mode to the hover mode and causes the display device 24 to display a hover cursor (S610). In addition, the display control unit 30 acquires a result of detection of the hover coordinates from the proximity detection touch panel 12 (S615), and acquires a result of detection of a tilt of the device body 11 from the tilt detection sensor 14 (S620).

Next, the display control unit 30 determines if a result of detection of a tilt of the line of sight has been acquired from the line-of-sight detection sensor 16 (S1105). If it is determined that the result has been acquired, the display control unit 30 determines an offset value in on the basis of the difference between the tilt of the device body 11 and the tilt of the line of sight (S1110). Hereinafter, the relationship between the difference between the tilt of the device body 11 and the tilt of the line of sight (hereinafter also simply referred to as a difference) and the offset value will be described specifically.

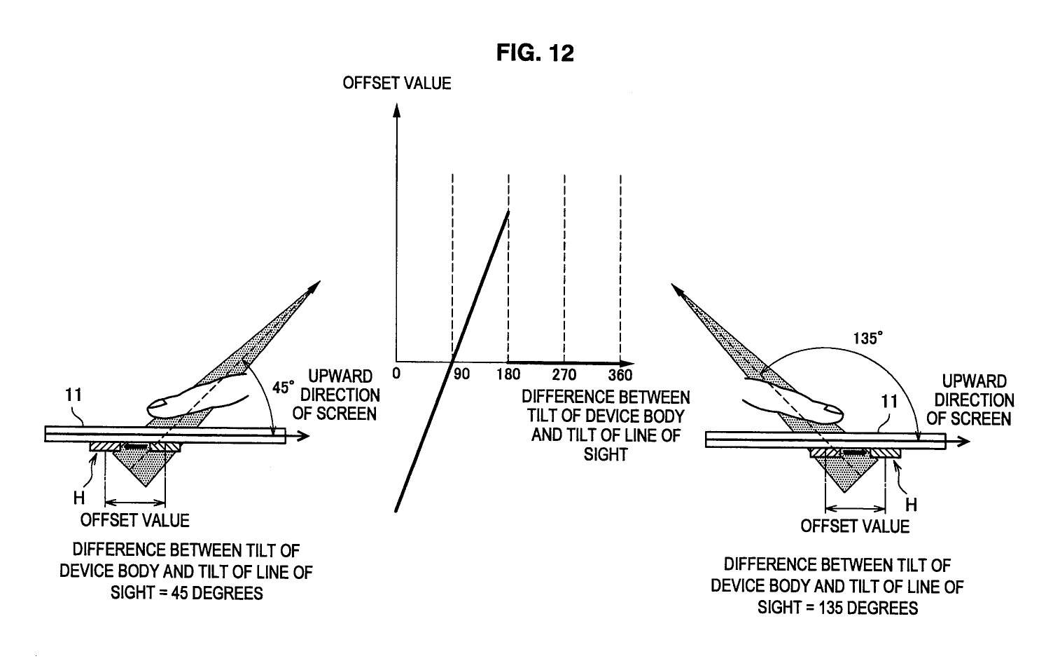

A graph shown in the center of FIG. 12 is a table showing the relationship between the difference between a tilt of the device body 11 and a tilt of the line of sight and an offset value. As shown in FIG. 12, when the difference between a tilt of the device body 11 and a tilt of the line of sight is in the range of 0 to 90 degrees, for example, the larger the difference, the higher the offset value. The offset value in this range is a negative value. Meanwhile, even when the difference between a tilt of the device body 11 and a tilt of the line of sight is in the range of 90 to 180 degrees, the larger the difference, the higher the offset value. The offset value in this range is a positive value.

When the difference between a tilt of the device body 11 and a tilt of the line of sight is in the range of 180 to 360 degrees, the offset value is zero independently of the value of the difference. This is because, when the difference is in the range of 180 to 360 degrees, the touch screen is seen from its rear side, which means that an offset process is not necessary.

Referring again to FIG. 11, when it is determined that a result of detection of the line of sight has not been acquired from the line-of-sight detection sensor 16 in step S1105, the display control unit 30 determines an offset value in accordance with the tilt of the device body 11 (S625).

Next, the display control unit 30 adds the offset value determined in S1110 or S625 to the hover coordinates detected in S615 (S630). Then, the display control unit 30 performs control so that a hover cursor is displayed at the hover coordinates after the offset calculated in S630 (S635). Hereinafter, display control of the hover cursor will be described more specifically with reference to FIGS. 12 and 13.

The right view and the left view of FIG. 12 show an offset value when the difference between a tilt of the device body 11 and a tilt of the line of sight is 45 degrees and 135 degrees, respectively. An offset value that is added to the hover coordinates when the difference is 45 degrees has the same absolute value as but an opposite (positive/negative) sign to the offset value added to the hover coordinates when the difference is 135 degrees. Accordingly, it becomes possible to prevent characters and the like that are the hover target indicated by the hover cursor H from being hidden behind the finger in accordance with the difference between a tilt of the device body 11 and a tilt of the line of sight, and display the hover cursor H at an appropriate position.

FIGS. 9 and 13 show hover display examples. As described previously, unless an offset value is added to the hover coordinates, characters and the like that are the hover target indicated by the hover cursor H are hidden behind the finger as shown in the left views of FIGS. 9 and 13. In this embodiment, it is possible to, by controlling an offset value variably in accordance with the difference between a tilt of the device body 11 and a tilt of the line of sight, perform control so that characters and the like that are the hover target indicated by the hover cursor H are not hidden behind the finger and the hover cursor H is not located too far from the finger. Accordingly, it becomes possible to easily distinguish whether the hover target correctly responds to the finger operation.

When the offset value is a negative value, the hover cursor H is located on the opposite side to the position when the offset value is a positive value as shown in the right view of FIG. 13. When the difference between a tilt of the device body 11 and a tilt of the line of sight is 0 to 90 degrees, the offset value is a negative value. Thus, the hover cursor H moves in a downward direction on the sheet as shown in the right view of FIG. 13. When the difference is in the range of 90 to 180 degrees, the offset value is a positive value. Thus, the hover cursor H moves in an upward direction on the sheet as shown in FIG. 9. Accordingly, it becomes possible to easily distinguish if the hover correctly responds to the finger operation even when an operation of seeing the screen from a direction opposite to the normal operation direction on the screen is performed. Note that in FIGS. 9 and 13, an offset process is performed in the y direction on the touch screen.

### 4. Third Embodiment

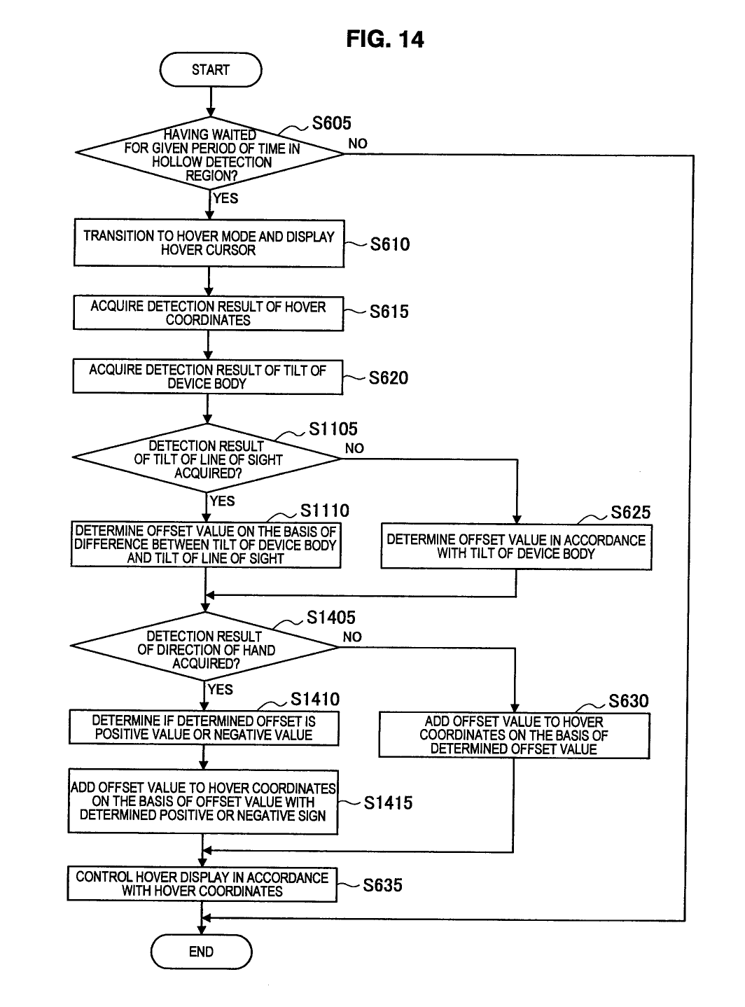

Finally, the information processing device 10 in accordance with the third embodiment will be described. The hardware configuration and the functional configuration of the information processing device 10 in accordance with the third embodiment are the same as those in the first embodiment. Thus, description thereof is omitted herein. Hereinafter, the operation of the information processing device 10 in accordance with the third embodiment will be described with reference to FIG. 14.

### (Operation)

FIG. 14 is a flowchart showing the operation of the information processing device 10 in accordance with the third embodiment. S605 to S625, S1105, and S1110 are the same as those in the second embodiment. Thus, description thereof is omitted herein. Through the series of such processes, an offset value is determined.

Next, the display control unit 30 determines if a result of detection of the direction of a hand has been acquired (S1405). The direction of a hand (the direction of a fingertip) is detected by detecting the direction of the base of the hand using the capacitive proximity detection touch panel 12. If it is determined that a result of detection of the direction of a hand has been acquired in S1405, the display control unit 30 determines if the offset value determined in S1110 or S625 is a positive value or a negative value (S1410). For example, as it is supposed that a face is positioned in the direction of the base of the hand on the basis of the direction of the hand, it follows that the line of sight is fixed on the touch screen from the direction of the base of the hand. Accordingly, the display control unit 30 determines if the offset value determined in S1110 or S625 is a positive value or a negative value so that the hover coordinates are offset to the opposite side of the direction of the hand in S1410. It is also possible to estimate the direction of the line of sight by detecting the direction of a finger instead of the direction of the hand.

Next, the display control unit 30 adds the offset value with the determined positive/negative sign to the hover coordinates detected in S615 (S1415). The display control unit 30 performs control so that a hover cursor is displayed at the offset hover coordinates calculated in S1415 (S635).

According to this embodiment, it is possible to control an offset value to a correct value by determining if the offset value is a positive value or a negative value. Accordingly, it is possible to prevent characters that are the hover target in a hover cursor from being hidden behind a finger and thus prevent the hover cursor from being located too far from the finger. Consequently, it becomes possible to easily distinguish whether the hover target correctly responds to the finger operation. In particular, in this embodiment, as it is determined if the offset value is a positive value or a negative value, it is possible to avoid the hover cursor H from being offset to a side opposite to the appropriate position.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, it is possible to determine an offset value of the hover coordinates in accordance with only a tilt of the line of sight instead of a tilt of the device body. In addition, each embodiment can be combined as appropriate.

Additionally, the present technology may also be configured as below.

(1)

An information processing device comprising a display control unit configured to identify hover coordinates displayed on a touch screen of a touch panel and a tilt of a device body, and determine an offset value of the identified hover coordinates in accordance with the identified tilt of the device body.

(2)

The information processing device according to (1), wherein the display control unit is further configured to identify a tilt of a line of sight with respect to the touch screen, and determine an offset value in accordance with the identified tilt of the line of sight and the tilt of the device body.

(3)

The information processing device according to (2), wherein the display control unit is configured to determine the offset value in accordance with a difference between the tilt of the device body and the tilt of the line of sight.

(4)

The information processing device according to (1), wherein the display control unit is configured to determine the offset value in accordance with the tilt of the device body on the basis of a table that associates and stores the tilt of the device body and the offset value.

(5)

The information processing device according to (3), wherein the display control unit is configured to determine the offset value in accordance with the difference between the tilt of the device body and the tilt of the line of sight on the basis of a table that associates and stores the difference between the tilt of the device body and the tilt of the line of sight and the offset value.

(6)

The information processing device according to any one of (1) to (5), wherein the display control unit is configured to move a hover display on the touch screen by correcting the hover coordinates using the offset value.

(7)

The information processing device according to (1), wherein the display control unit is further configured to identify a direction of a hand of an operator who is operating the touch screen, and determine if an offset value determined in accordance with the direction of the hand of the operator is a positive value or a negative value.

(8)

A display control method, including

identifying hover coordinates displayed on a touch screen of a touch panel;

identifying a tilt of a device body; and

determining an offset value of the identified hover coordinates in accordance with the identified tilt of the device body.

(9)

A program for causing a computer to execute:

a process of identifying hover coordinates displayed on a touch screen of a touch panel;

a process of identifying a tilt of a device body; and

a process of determining an offset value of the identified hover coordinates in accordance with the identified tilt of the device body.

The present disclosure contains subject matter related to that disclosed in Japanese Priority Patent Application JP 2011-118319 filed in the Japan Patent Office on May 26, 2011, the entire content of which is hereby incorporated by reference.

What is claimed is:

1. An information processing device comprising a display control unit configured to identify hover coordinates displayed on a touch screen of a touch panel and a tilt of a device body, and determine an offset value of the identified hover coordinates in accordance with the identified tilt of the device body.

2. The information processing device according to claim 1, wherein the display control unit is further configured to identify a tilt of a line of sight with respect to the touch screen, and determine an offset value in accordance with the identified tilt of the line of sight and the tilt of the device body.

3. The information processing device according to claim 2, wherein the display control unit is configured to determine the offset value in accordance with a difference between the tilt of the device body and the tilt of the line of sight.

4. The information processing device according to claim 1, wherein the display control unit is configured to determine the offset value in accordance with the tilt of the device body on the basis of a table that associates and stores the tilt of the device body and the offset value.

5. The information processing device according to claim 3, wherein the display control unit is configured to determine the offset value in accordance with the difference between the tilt of the device body and the tilt of the line of sight on the basis of a table that associates and stores the difference between the tilt of the device body and the tilt of the line of sight and the offset value.

6. The information processing device according to claim 1, wherein the display control unit is configured to move a hover display on the touch screen by correcting the hover coordinates using the offset value.

7. The information processing device according to claim 1, wherein the display control unit is further configured to identify a direction of a hand of an operator who is operating the touch screen, and determine if an offset value determined in accordance with the direction of the hand of the operator is a positive value or a negative value.

8. A display control method, comprising:
identifying hover coordinates displayed on a touch screen of a touch panel;
identifying a tilt of a device body; and
determining an offset value of the identified hover coordinates in accordance with the identified tilt of the device body.

9. A program for causing a computer to execute:
a process of identifying hover coordinates displayed on a touch screen of a touch panel;
a process of identifying a tilt of a device body; and
a process of determining an offset value of the identified hover coordinates in accordance with the identified tilt of the device body.
